(19) United States
(12) Patent Application Publication
(10) Pub. No.: US 2007/0217647 A1
(43) Pub. Date: Sep. 20, 2007

(54) Electro-Acoustic Converter, Module Using Same, Electronic Device, and Apparatus

(75) Inventors: Mitutaka Enomoto, Nara (JP); Kazutaka Kubo, Mie (JP); Masahide Sumiyama, Mie (JP); Tsuyoshi Yoshino, Kyoto (JP)

Correspondence Address: WENDEROTH, LIND & PONACK L.L.P., 2033 K. STREET, NW, SUITE 800, WASHINGTON, DC, 20006, US

(73) Assignee: Panasonic Electronic Devices Co., Ltd., Osaka (JP)

(21) Appl. No.: 11/587,536

(22) PCT Filed: Jun. 2, 2005
(86) PCT No.: PCT/JP05/10161

§ 371 Date: Oct. 25, 2006

(30) Foreign Application Priority Data
Jun. 11, 2004 (JP) 2004-173508

(51) Int. Cl. H04R 9/02

(52) U.S. Cl. 381/410; 381/400; 381/401

(57) ABSTRACT

Disclosed is a speaker comprising a frame connected with a magnetic circuit having a magnetic gap, a voice coil disposed adjacent to but not in contact with an upper side of the magnetic circuit, and a diaphragm bonded to a circumferential edge of the frame, wherein the frame and the diaphragm are configured into such peripheral shapes that conform to a mounting space allowed for the speaker inside an apparatus. This structure allows an external shape of the speaker to be freely configurable according to a limited space, yet the irregularly-shaped diaphragm is capable of being driven with an uniform amplitude, thereby providing an advantage of down-sizing and high performance.

### TECHNICAL FIELD

The present invention relates to electro-acoustic transducers used in various kinds of audio devices, video devices and data communications devices.

### BACKGROUND ART

FIG. 15 is a sectional view depicting a structure of a conventional speaker.

As shown in FIG. 15, magnet 1 is sandwiched between upper plate 2 and yoke 3 from top and bottom sides, and bonded to both of them. This structure composes magnetic circuit 4 of an inner-magnet type having an annularly-shaped magnetic gap 5.

Frame 6 is connected with the magnetic circuit in the center thereof. Voice coil 8 is placed in a freely movable manner inside magnetic gap 5. Voice coil 8 is bonded to the center of diaphragm 7, the periphery of which is then attached to a circumferential edge of frame 6.

In the conventional speaker constructed as shown above, diaphragm 7 bonded to voice coil 8 vibrates and reproduces sound when an electric signal is input to drive voice coil 8 in a vertical direction inside magnetic gap 5.

Some examples known as the prior art documents relating to the invention of the present application include Japanese Patent Unexamined Publications, No. 2002-78082 and No. 2004-56278.

The electro-acoustic transducer of the prior art discussed above has a problem, however, that reduction in size of the electro-acoustic transducer cannot catch up with a pace of rapid advancement in downsizing, thin-profiling, and multi-fictionalization of the product, which gives rise to a substantial reduction in space available inside the product for mounting the transducer, or a speaker.

In the case of mobile telephones, in particular, the multi-fictionalization has been advancing at a remarkable pace far exceeding anyone's imagination as compared to the effort of downsizing and thin-profiling. For this reason, it has become common for such products to carry a large number of new components that have never been available before. There is hence a problem in an extreme case that no useful space can be made available for mounting the electro-acoustic transducer.

In circumstances such as above, any conventional electro-acoustic transducer having an external shape of certain regularity typified by a round shape, oval, elongated oval, square, regular polygon, and the like shapes presents a serious problem that it is not adaptable for installation in a space provided for the electro-acoustic transducer within a mobile telephone.

### SUMMARY OF THE INVENTION

The present invention addresses the above problems of the prior art, and it is an object of this invention to provide an electro-acoustic transducer of a small size, low profile, high performance, and an external shape freely configurable in conformity to a limited mounting space.

This invention discloses the electro-acoustic transducer which comprises a magnetic circuit having a magnetic gap, a frame connected with the magnetic circuit, a voice coil disposed adjacent to but not in contact with the magnetic circuit, and a diaphragm bonded to a circumferential edge of the frame, wherein the frame and the diaphragm are configured into shapes having no regularity.

### BRIEF DESCRIPTION OF DRAWINGS

FIG. 1 is a plan view depicting a configuration of a speaker, which represents one of electro-acoustic transducers according to a first exemplary embodiment of the present invention;

FIG. 2 is a sectional view of the same speaker taken along the line 2-2 in FIG. 1;

FIG. 3 is a plan view of the same speaker with a diaphragm removed;

FIG. 4 is a sectional view of the same speaker taken along the line 4-4 in FIG. 3;

FIG. 5 is a plan view depicting a structure of a diaphragm of a speaker according to a second exemplary embodiment of the present invention;

FIG. 6 is a sectional view of the diaphragm of the speaker taken along the line 6-6 in FIG. 5;

FIG. 7 is a plan view depicting a structure of the speaker according to the second exemplary embodiment of this invention;

FIG. 8 is a sectional view of the same speaker taken along the line 8-8 in FIG. 7;

FIG. 9 is a plan view depicting a structure of a diaphragm of a speaker according to a third exemplary embodiment of the present invention;

FIG. 10 is a plan view depicting a configuration of the same speaker;

FIG. 11 is a sectional view of the same speaker taken along the line 11-11 in FIG. 10;

FIG. 12 is a sectional view of a speaker module according to a fourth exemplary embodiment of the present invention;

FIG. 13 is a perspective view of a mobile telephone incorporating a speaker according to a fifth exemplary embodiment of the present invention;

FIG. 14 is a sectional view of an automobile according to a sixth exemplary embodiment of the present invention; and

FIG. 15 is a sectional view depicting a structure of a speaker of the prior art.

### REFERENCE MARKS IN THE DRAWINGS

21 magnet
22 upper plate
23 yoke
23A sound passage opening in yoke
24 magnetic circuit
25 magnetic gap
26 frame
27, 27A and 27B diaphragm 28, 28A and 28B voice coil
30 speaker
40 electronic circuit
41 circuit board
42 electronic component
50 speaker module
60 display module
65 control panel
66 microphone
67 camera
68 receiver
70 housing case
80 mobile telephone
90 automobile

### DETAILED DESCRIPTION OF PREFERRED EMBODIMENTS

### First Exemplary Embodiment

Description is provided hereinafter of a first exemplary embodiment, an electro-acoustic transducer according to the present invention.

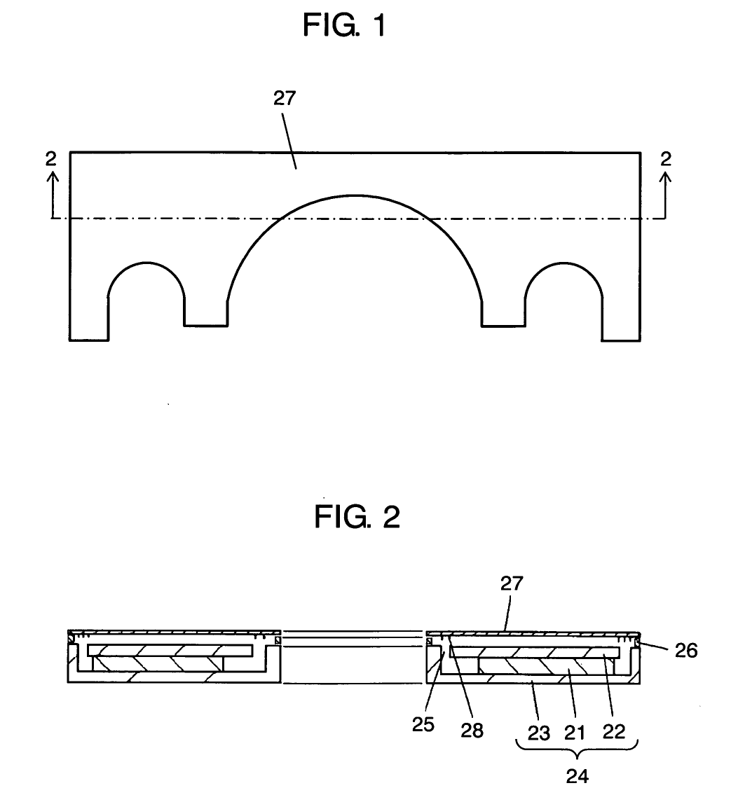

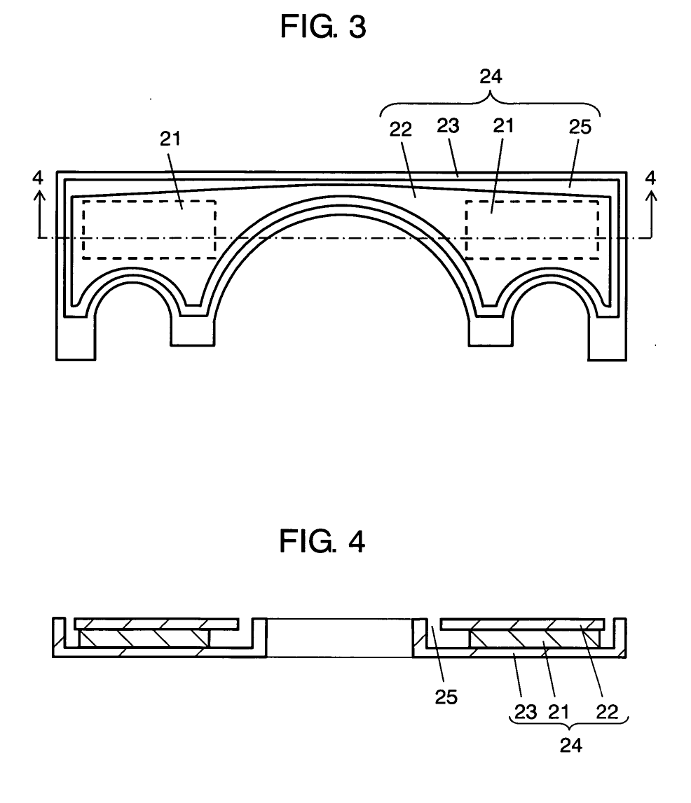

FIG. 1 is a plan view depicting a configuration of a speaker representing one of the electro-acoustic transducer according to the first exemplary embodiment of this invention, FIG. 2 a sectional view of the same speaker taken along the line 2-2 in FIG. 1, FIG. 3 a plan view of the same speaker with a diaphragm removed, and FIG. 4 a sectional view of the same speaker taken along the line 4-4 in FIG. 3.

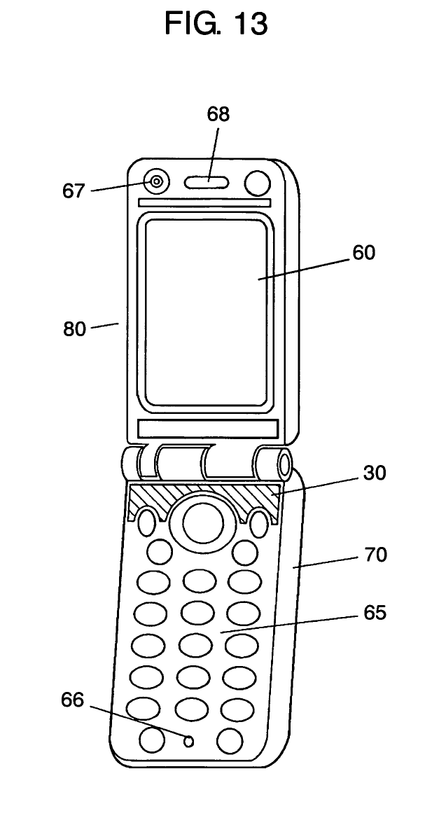

This speaker is configured into such an external shape that is free from any regularity so as to make it in conformity to a mounting space allowed for an electro-acoustic transducer inside an electronic device such as a mobile telephone shown in FIG. 13.

In the instance here, FIG. 13 shows a perspective view of the mobile telephone equipped with the speaker, which represents one of the electro-acoustic transducers according to the first exemplary embodiment of this invention. In other words, the speaker is configured into the shape corresponding to the available mounting space, since any other speaker having a regular shape such as round, oval, elongated oval, square, regular polygon, and the like shape are not mountable, or a usable area for mounting the speaker is extremely limited.

Accordingly, a shape of the shaded area shown in FIG. 13 illustrates only one example. The shape shown is therefore not restrictive, and that the invention can be embodied freely into any other shape not having a regularity in the outer configuration. Preferably, the shape may be such that it can achieve a largest area possible to fit into the mounting space available inside the electronic device.

In the first exemplary embodiment of this invention, although what is illustrated is the speaker as an example of the electro-acoustic transducer, this is not restrictive, and the invention can be embodied in all kinds of electro-acoustic transducers such as a receiver, a sounder and a microphone.

In FIG. 1 to FIG. 4, the speaker of the first exemplary embodiment according to this invention comprises magnet 21, upper plate 22, yoke 23, magnetic circuit 24, magnetic gap 25, frame 26, diaphragm 27 and voice coil 28.

Description is provided here of the principle of how this speaker operates. A magnetic flux generated in magnetic circuit 24 leaks through magnetic gap 25. This magnetic flux acts on voice coil 28 bonded to diaphragm 27 having an external shape suitable for being disposed adjacent to magnetic circuit 24 without in contact thereto. When a signal is input to this voice coil 28, diaphragm 27 vibrates vertically in response to the input signal to generate sound.

Voice coil 28 may be made of at least one layer of winding to fulfill the function. However, a multi-layered winding having two or more coil layers can increase its driving force to improve a level of sound pressure of the speaker. Although voice coil 28 is bonded to diaphragm 27 on the surface confronting magnetic circuit 24, i.e., the back surface of diaphragm 27, it may be placed on the front surface of diaphragm 27, or even on both of the front and back surfaces.

Diaphragm 27 shown here is made of a resin. This structure can achieve the diaphragm of light weight and low cost, thereby maintaining the improvement in the level of sound pressure of the speaker and also reducing the cost of the speaker.

In addition, external dimensions of frame 26 and external dimensions of diaphragm 27 are so configured as to be substantially equal, as shown in FIG. 2.

This structure makes the largest external dimensions possible for diaphragm 27. In other words, an overall area of diaphragm 27 can be increased to its maximum extent in order to improve an efficiency of the speaker such as enhancement of the level of sound pressure.

Voice coil 28 bonded to diaphragm 27 is so constructed that it includes a portion of the coil wound along at least a part of the outer periphery of diaphragm 27, and it is disposed on the surface of diaphragm 27 in a configuration of the wound coil.

Since this structure ensures presence of voice coil 28 at least partly near the outer periphery of diaphragm 27, it can accomplish an uniform amplitude of vibration even though diaphragm 27 has the irregular shape rather than a certain regularity.

In addition, a shape of the magnetic gap of the speaker is substantially analogous to that of the outer periphery of the diaphragm.

By making the shape of the magnetic gap configured in this manner to conform with the shape of the outer periphery of the frame, the diaphragm can be driven to vibrate uniformity and efficiently while reducing undesired resonance even though the diaphragm has the irregular shape.

It can thus improve a frequency characteristic and achieve better performance of the speaker.

As described, the speaker according to the first exemplary embodiment of this invention has an advantage when used in such a device as a mobile telephone, where there is only an extremely limited space available for installation of the speaker, that its external shape can be configured freely into conformity to the limited space. Even though the diaphragm has the irregular shape without certain regularity, it can generate vibration of an uniform amplitude. Accordingly, the invention can substantially improve a degree of flexibility for mounting the speaker into the device while maintaining the features of small size and high performance.

### Second Exemplary Embodiment

Description is provided hereinafter of a second exemplary embodiment, or an electro-acoustic transducer, according to the present invention.

According to the second exemplary embodiment of this invention, diaphragm 27 discussed in the first exemplary embodiment is placed between magnetic circuits 24, which are arranged in a manner to confront each other at both the upper side and the lower side of diaphragm 27. In addition, voice coils 28 are bonded to both the front and back surfaces of diaphragm 27.

Since the structure other than the above is similar to that of the first exemplary embodiment, like reference marks are used throughout to designate like components, and their detailed explanation will be omitted. Referring to the drawings, description will be provided below for only different components.

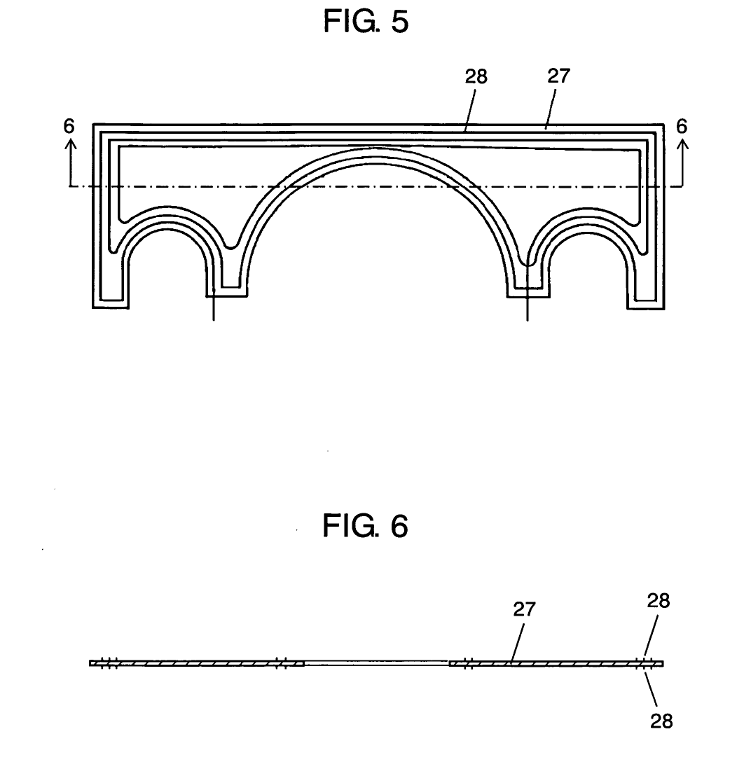

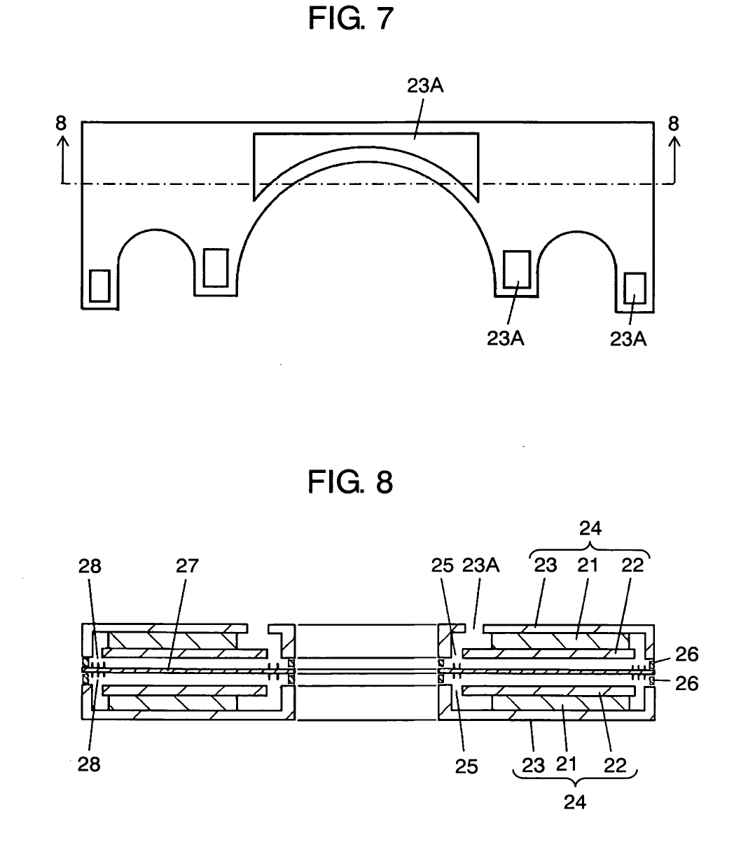

FIG. 5 is a plan view depicting a structure of diaphragm 27 of the speaker according to the second exemplary embodiment of this invention, FIG. 6 a sectional view of the same diaphragm 27 taken along the line 6-6 in FIG. 5, FIG. 7 a plan view depicting a structure of the speaker according to the second exemplary embodiment of this invention and FIG. 8 a sectional view of the same speaker taken along the line 8-8 in FIG. 7. In FIG. 7 and FIG. 8, the speaker has sound passage opening 23A in its yoke.

In the speaker according to the second exemplary embodiment of this invention, diaphragm 27 is provided with voice coils 28, which are bonded to both the front and back surfaces thereof, and that they are wound into a plurality of layers, as shown in FIG. 5 and FIG. 6, in order to improve a level of sound pressure especially for use as a speaker. Additionally, magnetic circuits 24 are arranged at both the upper and the lower sides of diaphragm 27 in a manner to confront each other as shown in FIG. 7 and FIG. 8.

In this case, two magnetic circuits 24 of the same specification as described in the first exemplary embodiment may be used for both the upper and the lower sides, or one of magnetic circuits 24 at the upper side may be so arranged that it covers only a part of the surface area where needed rather than the entire surface. In addition, yoke 23 of magnetic circuit 24 on the upper side is provided with sound passage opening 23A to improve a sound transmission efficiency for further improvement of the level of sound pressure of the speaker.

Since magnetic circuits 24 are arranged symmetrically across diaphragm 27, as discussed above, the speaker according to this exemplary embodiment can further improve the level of sound pressure and achieve the speaker of small size and high performance.

### Third Exemplary Embodiment

Description is provided hereinafter of a third exemplary embodiment, or an electro-acoustic transducer, according to the present invention.

In the third exemplary embodiment of this invention, two or more voice coils of different kinds are bonded to the diaphragm of the speaker discussed in the first exemplary embodiment.

Since the structure other than the above is similar to that of the first exemplary embodiment, like reference marks are used throughout to designate like components, and their detailed explanation will be omitted. Description will be provided hereinafter only for different components with reference to the drawings.

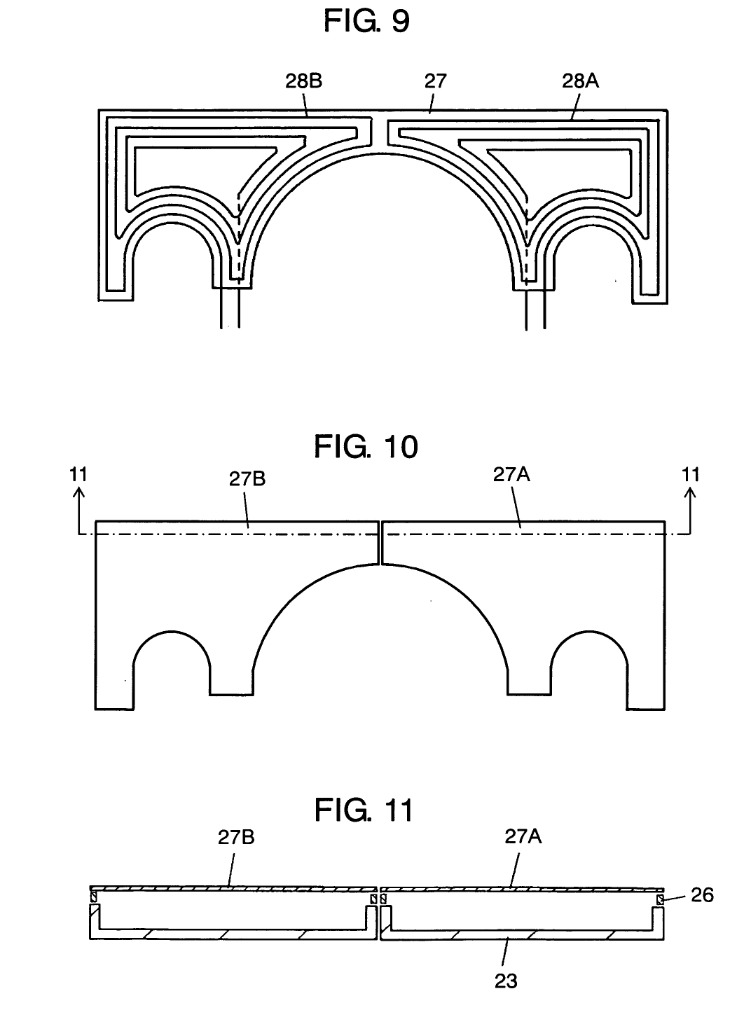

FIG. 9 is a plan view depicting a structure of the diaphragm of the speaker according to the third exemplary embodiment of this invention. In FIG. 9, the speaker of this invention is provided with diaphragm 27, first voice coil 28A and second voice coil 28B. The invention can thus achieve easily the speaker adaptable for stereo system by providing the two voice coils on one sheet of diaphragm 27.

Moreover, the invention is not limited to this third exemplary embodiment, but the speaker may be provided with a variety of voice coils having different areas, so that the individual voice coils may be input with signals of different frequency bands to make it function as a multi-way system.

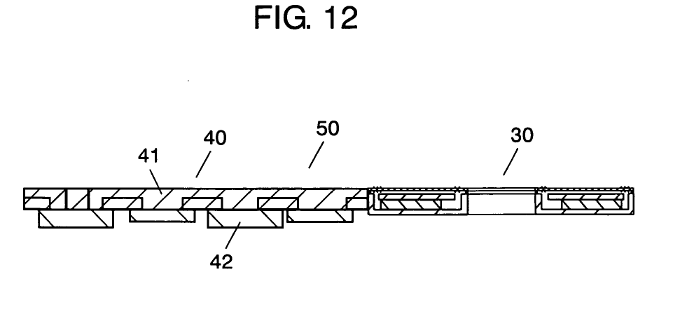

FIG. 10 is a plan view depicting a structure of the speaker according to the third exemplary embodiment of this invention, and FIG. 11 is a sectional view of the same speaker as taken along the line 11-11 in FIG. 10. When the speaker is adapted for the stereo system or the multi-way system, it is possible to improve the channel separation by composing a discontinuous structure of diaphragms 27A and 27B corresponding to the respective voice coils 28A and 28B shown in FIG. 9.

The discontinuous structure consisting of a plurality of individually composed diaphragms can avoid vibrations of different channels from causing adverse influences to one another, thereby reducing cross talk and improving the channel separation.

Furthermore, the speaker may be provided with separate magnetic circuits corresponding individually to the plurality of different kinds of voice coils bonded to their respective diaphragms. This enables the magnetic circuits to drive the individual voice coils and diaphragms more minutely and precisely so as to improve the performance of the speaker.

As discussed, the speaker according to the third exemplary embodiment of this invention comprises two or more voice coils of different kinds bonded to the diaphragm, which can hence reproduce a variety of sounds with only a single unit of the speaker.

In the first exemplary embodiment of this invention, the voice coil composing the speaker is fabricated by the process of etching or plating a metallic material. However, this is not restrictive, and that the voice coil may be produced with a metal wire provided with an insulation coating (e.g., a magnet wire for general use). This can result in improvement of the productivity and low cost. Here, the magnet wire needs not be a round shape in cross section, but it can be a square shape. Use of the square shape can improve a space factor of the coil, and hence the level of sound pressure of the speaker.

Alternatively, this voice coil may be composed of a metal foil, or it may be composed of an electro-conductive ink. Use of these materials improves an accuracy and a degree of flexibility of forming the shape of the voice coil, achieves reduction in thickness and weight of the voile coil, and thereby enables accurate fabrication of the voice coil according to the irregular shape of the diaphragm. As a result, they can improve performance of the speaker, achieve low profiling, and further improve the level of sound pressure.

In the first exemplary embodiment of this invention, the diaphragm composing the speaker is made of a resin material, and bonded directly to the frame. However, this is not restrictive, and that the diaphragm and the frame of this speaker may be connected by way of another material having flexibility. Alternatively, the frame itself may be made of a material having flexibility so that it can be connected directly to the diaphragm of this speaker. Resin group and rubber group materials such as silicon rubber, foam rubber, and polyurethane foam are commonly used as the material having flexibility.

The structure made in this manner provides the speaker of this invention with the diaphragm capable of more efficiently producing an amplitude of vibration.

### Fourth Exemplary Embodiment

Description is provided hereinafter of a fourth exemplary embodiment, a module equipped with an electro-acoustic transducer according to the present invention.

FIG. 12 is a sectional view of a speaker module according to the fourth exemplary embodiment of the present invention. As shown in FIG. 12, speaker module 50 comprises speaker 30 described in the exemplary embodiment as the electro-acoustic transducer of this invention, which is integrated with electronic circuit 40. That is, electronic circuit 40 comprises electronic components 42 mounted and wired on circuit board 41. This electronic circuit 40 is then connected integrally with speaker 30 to compose speaker module 50.

This electronic circuit 40 includes at least an amplifier circuit for audio signals to be supplied to the speaker. The circuit for amplifying pre-processed audio signals to a level necessary to output from the speaker is integrated with speaker 30 together with the associated internal wiring of the circuit. When connected, this speaker module 50 can easily provide an audio output.

In addition, this electronic circuit 40 can be designed to include various circuits besides the above amplifier circuit, such as a detector circuit, a modulator circuit, a demodulator circuit and the like required for communications, a drive circuit for display means such as a liquid crystal panel, a power supply circuit and a charging circuit in the case of a telecommunications device such as a mobile telephone.

The invention is aimed to combine the processes of production, inspection and distribution by modularizing into an integrated unit the speaker and the electronic circuits, which have hitherto been produced and supplied separately to a production base of the electronic devices such as mobile telephones by way of their respective inspection process and distribution process. As a result, speaker module 50 comprised of the integrated unit of speaker 30 and electronic circuit 40 can be supplied at a low cost.

### Fifth Exemplary Embodiment

Description is provided hereinafter of a fifth exemplary embodiment of an electronic device equipped with an electro-acoustic transducer according to the present invention.

FIG. 13 is a perspective view of a mobile telephone equipped with a speaker according to the fifth exemplary embodiment of the present invention. As shown in FIG. 13, mobile telephone 80 is constructed using speaker 30 described in the above exemplary embodiment as the electro-acoustic transducer of this invention. In other words, mobile telephone 80 comprises individual components and modules such as this speaker 30, display module 60, e.g., a liquid crystal panel, control panel 65, microphone 66, camera 67 and receiver 68, which are mounted inside housing case 70 together with other electronic circuits.

According to this structure, the speaker can be housed inside the device having an extremely limited space allowed for installation of the speaker, since it has the diaphragm, of which an external shape can be configured freely according to the limited space. This provides an advantage of down-sizing the electronic device such as a mobile telephone while maintaining the feature of high performance.

### Sixth Exemplary Embodiment

Description is provided hereinafter of a sixth exemplary embodiment of an apparatus equipped with an electro-acoustic transducer according to the present invention.

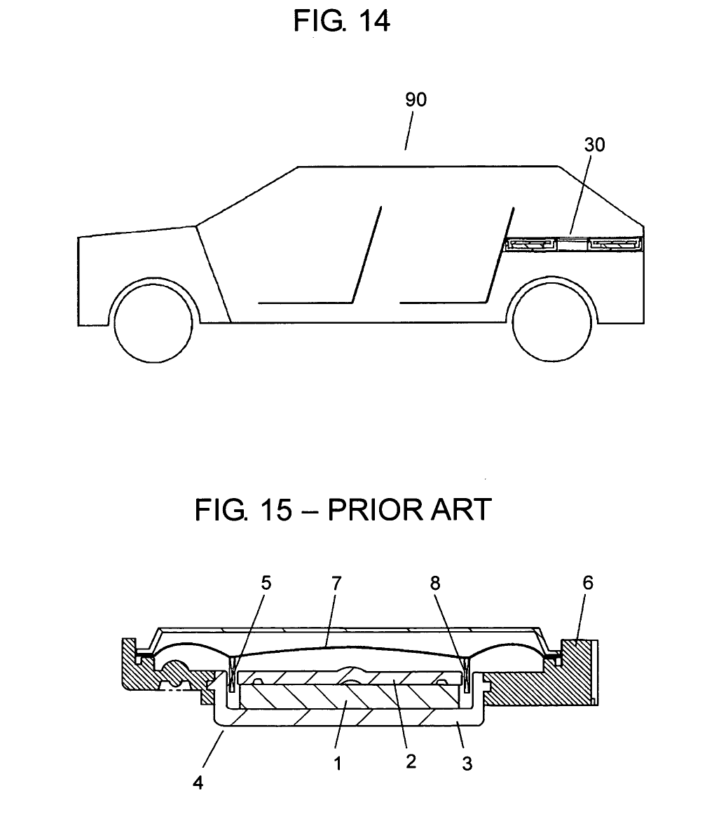

FIG. 14 is a sectional view of automobile 90 according to the sixth exemplary embodiment of the present invention. As shown in FIG. 14, automobile 90 comprises speaker 30 of this invention built inside either a rear tray or a front panel, and used as a part of an automobile navigation or an automobile audio system.

According to the structure illustrated, the speaker can be built into the automobile having an extremely limited space available for installation of the speaker, since it has the diaphragm of irregular configuration, of which an external shape can be configured freely according to the limited space. This provides an advantage of down-sizing the apparatus such as the automobile while maintaining the feature of high performance.

### INDUSTRIAL APPLICABILITY

A speaker according to the present invention can be freely configured of its external shape into conformity to a limited mounting space available for installation of the speaker. Although it has a diaphragm of irregular shape without any regularity, it can generate vibration of an uniform amplitude Accordingly, the invention can substantially improve a degree of flexibility for mounting the speaker into an apparatus while maintaining features of small size and high performance. Moreover, the speaker of this invention is useful as an electro-acoustic transducer primarily for data communications devices such as mobile telephones as well as other electronic devices that are sought to be small in size, thin profile and multi functional.

1. An electro-acoustic transducer comprising:
a magnetic circuit having a magnetic gap;
a frame connected with the magnetic circuit;
a voice coil disposed adjacent to but not in contact with the magnetic circuits; and
a diaphragm bonded to a circumferential edge of the frame,
wherein the frame and the diaphragm are configured into shapes having no regularity.

2. The electro-acoustic transducer according to claim 1, wherein external dimensions of the frame and external dimensions of the diaphragm are configured to be substantially equal.

3. The electro-acoustic transducer according to claim 2, wherein the voice coil includes a portion wound along at least a part of an outer periphery of the diaphragm, and disposed on a surface of the diaphragm in a configuration of wound coil.

4. The electro-acoustic transducer according to claim 2, wherein the magnetic circuit is arranged at the front and back sides of the diaphragm in a confronting manner.

5. The electro-acoustic transducer according to claim 2, wherein the voice coil is bonded to the diaphragm.

6. The electro-acoustic transducer according to claim 2, wherein the magnetic gap has a shape substantially analogous to a shape of an outer periphery of the diaphragm.

7. The electro-acoustic transducer according to claim 2, wherein the diaphragm is bonded with a plurality of voice coils of different kinds.

8. The electro-acoustic transducer according to claim 7, wherein the plurality of voice coils of different kinds individually perform reproduction of different frequency bands.

9. The electro-acoustic transducer according to claim 7, wherein the diaphragm has a discontinuous structure corresponding to the plurality of voice coils of different kinds.

10. The electro-acoustic transducer according to claim 7 comprising a plurality of magnetic circuits corresponding to the plurality of voice coils of different kinds respectively.

11. The electro-acoustic transducer according to claim 1, wherein the voice coil is made of a metal wire having an insulation coating.

12. The electro-acoustic transducer according to claim 1, wherein the voice coil is made of a metal foil.

13. The electro-acoustic transducer according to claim 1, wherein the voice coil is made of an electro-conductive ink.

14. The electro-acoustic transducer according to claim 1, wherein the diaphragm is connected to the frame through a material having flexibility.

15. The electro-acoustic transducer according to claim 1, wherein the diaphragm is made of a resin.

16. A module comprising an electro-acoustic transducer of claim 1, and an electronic circuit connected thereto.

17. An electronic device equipped with an electro-acoustic transducer of claim 1.

18. An apparatus equipped with an electro-acoustic transducer of claim 1.
